(19) United States
(12) Patent Application Publication
(10) Pub. No.: US 2009/0313628 A1
(43) Pub. Date: Dec. 17, 2009

(54) DYNAMICALLY BATCHING REMOTE OBJECT MODEL COMMANDS

(75) Inventors: Shaofeng Zhu, Bellevue, WA (US); Michael Ammerlaan, Sammamish, WA (US); Michael Yu.Kae. Cheng, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/139,242

(22) Filed: Jun. 13, 2008

(51) Int. Cl. G06F 9/46

(52) U.S. Cl. 718/101

(57) ABSTRACT

A client-server architecture provides mechanisms to assist in minimizing round trips between a client and server. The architecture exposes an object model for client use that is structured similarly to the server based object model. The client batches commands and then determines when to execute the batched commands on the server. Proxy objects act as proxies for objects and serve as a way to suggest additional data retrieval operations for objects which have not been retrieved. Conditional logic and exceptions may be handled on the server without requiring additional roundtrips between the client and server.

### BACKGROUND

Increasingly, Internet-enabled applications are built using a client-server, three-tier, or n-tier model whereby the user experience and interface are provided on a different machines from the machines that provide the business logic. For example, logic may be executed within the browser and the data is communicated back and forth to a web server. Generally, the client code calls a variety of web services and/or remote procedure calls to perform operations such as reading data, writing data, or performing actions on that data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A client-server architecture provides mechanisms to assist in minimizing round trips between a client and server. The architecture exposes an object model for client use that is structured similarly to the server based object model. The client batches commands and then determines when to execute the batched commands on the server. Proxy objects act as proxies for objects and serve as a way to suggest additional data retrieval operations for objects which have not been retrieved. Conditional logic and exceptions may be handled on the server without requiring additional roundtrips between the client and server.

### BRIEF DESCRIPTION OF THE DRAWINGS

FIG. 1 illustrates an exemplary computing device;

FIG. 2 shows a batching system for batching commands on a client before sending them to a server for execution;

FIG. 3 illustrates example conditional logic code that may be included in the batched commands; and

FIG. 4 shows an illustrative process for batching commands.

### DETAILED DESCRIPTION

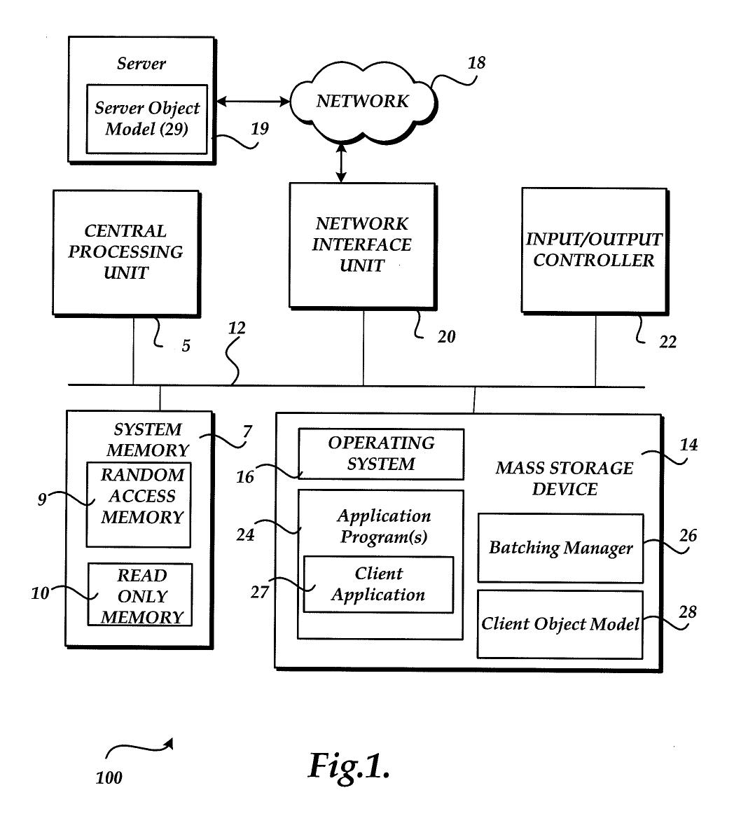

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured different ways, including as a as a desktop or mobile computer, and includes a central processing unit 5 (“CPU”), a system memory 7, including a random access memory 9 (“RAM”) and a read-only memory (“ROM”) 10, and a system bus 12 that couples the memory to the CPU 5. A basic input/output system containing the basic routines that help to transfer information between elements within the computer, such as during startup, is stored in the ROM 10. The computer 100 further includes a mass storage device 14 for storing an operating system 16, application programs 24, client application 27, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100

Computer 100 operates in a networked environment using logical connections to remote computers, such as server 19, through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS VISTA® operating system from MICROSOFT CORPORATION of Redmond, Wash. The mass storage device 14 and RAM 9 may also store one or more program modules. In particular, the mass storage device 14 and the RAM 9 may store one or more application programs 24. One such application program is a client application 27 that utilizes client object model 28 and interacts with server 19. Batching manager 26 is configured to assist in minimizing round trips between the client and server (e.g. server 19) to implement common actions. While illustrated separately from client application 27, the functionality of batching manager 26 may be included within client application 27, or at some other point within computer 100. Client object model 28 is substantially similar to the server object model 29 that is located on server 19. Generally described, client object model 28 and server object model 29 are a collection of objects or classes through which an application can examine and manipulate the object-oriented interface to a service or system. For example, one type of object model is the HTML Document Object Model (DOM) that is a collection of objects that represent a page in a web browser. The DOM is used by programs to examine and dynamically change the page. Many other types of object models exist.

Client application 27 batches commands in its client code until a determination is made to execute them on the server. Batching manager 26 is configured to build a list of commands to execute based on the commands that are batched by the client application. When the client determines to execute the batched commands, batching manager 26 sends the commands to server 19 for execution. Batching the commands on the client side helps to minimize the data communication cost (due to the reduced number of roundtrips) between the client and server. Exception cases and conditional logic may also be included within the batched commands such that exceptions and conditions can be handled without requiring additional roundtrips between the client and server. Additionally, the server may return a proxy object that acts as a proxy for an object and serves as a way to perform operations on the object (i.e. request additional data, set data) even though the object was not retrieved from the server.

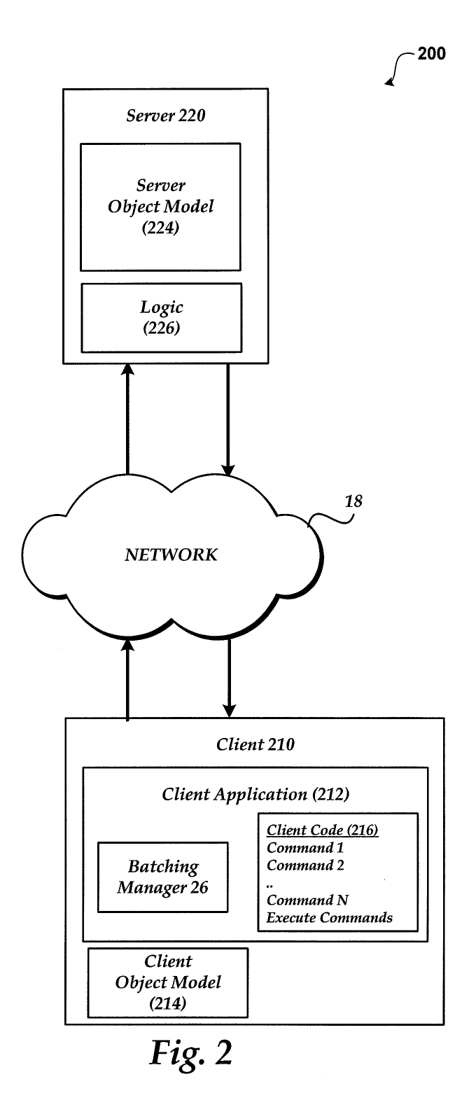

FIG. 2 shows a batching system 200 for batching commands on a client before sending them to a server for execution. As illustrated, batching system 200 includes client 210 and server 220. Client 210 includes client application 212, batching manager 26, and client object model 214. Server 220 includes server object model 224 and logic 226.

Server 220 exposes different operations from server object model 224 in client object model 214. The client object model 214 is similar to the server object model 224 on the server 220. From the perspective of the developer of the client application 212, working with client object model 214 on client 210 is similar to working with the server object model 224 directly on server 220. According to one embodiment, the objects on the client are approximately equivalent to the objects on the server. For example, all of the operations available on the server may be available on the client. According to one embodiment, to make an object available on the client, the object is marked on the server as being available for clients. All or a portion of the data and functionality that is associated with the objects in the server object model may be exposed within the client object model. In this way, the same call made on the client works properly (without change) when executed on the server. The object model may be an object model such as JavaScript in a web browser, or a managed client object model for a remote internet application.

According to one embodiment, objects and their members within the server object model 224 to be included in the client object model 214 are marked with a client callable attribute. Marking the object and members indicates that the member is callable remotely via object model, and constitutes an assertion that the member is safe to be invoked remotely. The client callable attribute may also declare several attributes for describing how the member should be exposed in the client object model, such as an alternate name for the attribute. According to one embodiment, based on these attributes, proxy object models (i.e. a managed code and a JavaScript OM) are generated. This provides the benefit that the client/JavaScript object models are “in sync” with the server object model 224, and that new methods can be added to the client object model 214 simply by adding new Client Callable attributes and generating a proxy. The generated object models (a .js file and a managed .dll respectively) can be used by customers just like any other object model. These proxies present an object oriented corresponding view of the object model. As solutions on clients use the client side object model, a log is recorded in XML of the operations specified. There may be some client side-only logic as well for doing basic tasks such as collection enumeration.

Client 210 is in full control of the batching semantic. Each command within the client code 216 of the client application 212 is automatically batched until an explicit command (i.e. Execute Commands) is called. In other words, a developer does not need to specifically indicate that the command is to be batched. In this way, a developer can determine exactly what they wish to retrieve from the server by calling explicit operations within the object model rather than relying on a provided command from the server. In the present example, commands 1−N are batched and then sent to the server as a group when the command Execute Commands is called. Batching manager 26 builds a list of the batched commands to execute when instructed.

When the batched commands are received on server 220, each of the batched commands are executed using the corresponding object model in the server object model 224 located on the server. According to one embodiment, a web service (such as an HttpHandler) is provided, which serves as the receptacle of the batch of commands. This service in turn calls the corresponding object model. Data that the object model might return (e.g., the value of a get property) are recorded and associated with corresponding objects. The result is returned as compacted JavaScript Object Notation (JSON), which the underlying proxy then parses and associates with the right objects. When the execute command call returns to the client (either synchronously or asynchronously), developers can access the results of the query naturally on the objects they initiated the query from.

Object identity may also be provided for objects, meaning that multiple operations and multiple queries can happen with the same object over time. The system is intelligent to realize and be able to associate client objects with their server counterparts overtime.

Several checks may also be performed to help ensure the security of the system. First, objects and members which are marked as client callable are allowed to be called, which makes calling the object model an opt-in process. Second, there are timeouts on the amount of time for operations requested by the proxy, as well as limits on the overall number of “expensive objects” (i.e. computationally expensive) that can be instantiated at any one time. Third, the server administrator could explicitly block some APIs that are marked as client callable.

As data is retrieved from the server 220, developers may need to further request data for objects that might not have been retrieved yet. For example, if someone has a representative Site object, they may request to retrieve all Lists in that site. But they may also request to receive all the list items for each List object. Since the Site query has not actually executed and no lists are retrieved (there may be 0 lists in the site or 100 lists in the site), a proxy object is exposed, which serves as a way to suggest additional data retrieval operations for objects which have not been retrieved yet.

Some operations to retrieve data or perform operations may throw errors on the server. This may require further operations to compensate for these errors. For example, if a list does not exist, the operation may be to create a new instance of that list. To further minimize the need for multiple communications from client to server to implement this scenario, logic may be included within the batched commands to control what happens when errors are thrown in code, and errors are thrown in error handling code. According to one embodiment, this is done using a familiar developer construct related to try/catch/finally.

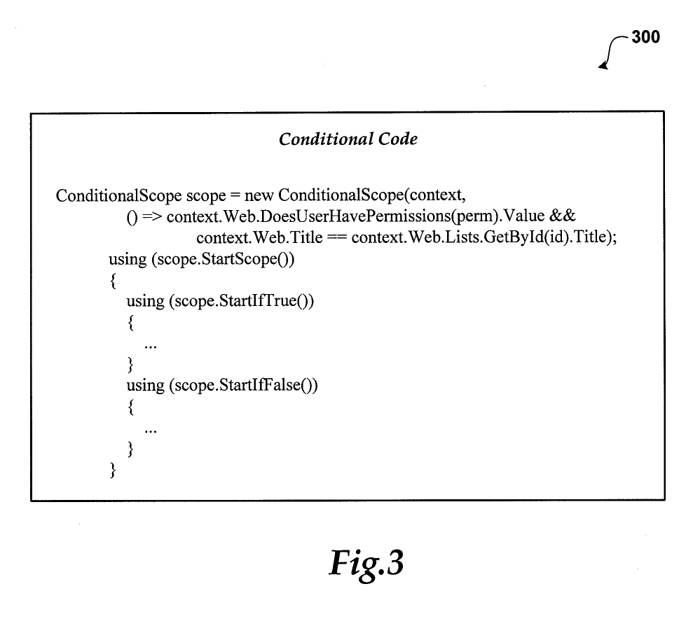

Conditional logic may also be included within client code 216 to assist in reducing the communication between the client and the server. For example, conditions such as: =, ≠, >, <, ≧, ≦, may be utilized to evaluate an expression on the server and when evaluated perform the appropriate command(s) that meet the condition (See FIG. 3 for example).

FIG. 3 illustrates example conditional logic code 300 that may be included in the batched commands.

A client side developer may use conditional logic within the batched commands to express what happens if data on the server matches a particular condition. According to one embodiment, a client expresses a logical tree of conditions, using a programming technique such as LINQ (Language Integrated Query) that is a MICROSOFT .NET framework component. The expression tree is serialized and sent to the server for it to consume.

The following is exemplary code:

```
        ConditionalScope scope = new ConditionalScope(context,
    ( ) => context.Web.DoesUserHavePermissions(perm).Value &&
            context.Web.Title == context.Web.Lists.GetById(id).Title);
using (scope.StartScope( ))
{
    using (scope.StartIfTrue( ))
    {
        ...
    }
    using (scope.StartIfFalse( ))
    {
        ...
    }
}
```

In this syntax, the condition of (whether the user has permissions to edit a web and whether a web title matches a certain list title) is expressed using LINQ syntax. The batching infrastructure automatically serializes the expression tree implied by the syntax. Then, via natural programming syntax on the client, a developer can express operations that should happen if true or false is set. This provides the client developer the benefit of being able to express conditions in the batch in a relatively ‘natural’ and straight forward manner, while still retaining the benefit that operations are processed in “one round trip” even if logic for doing operations differ.

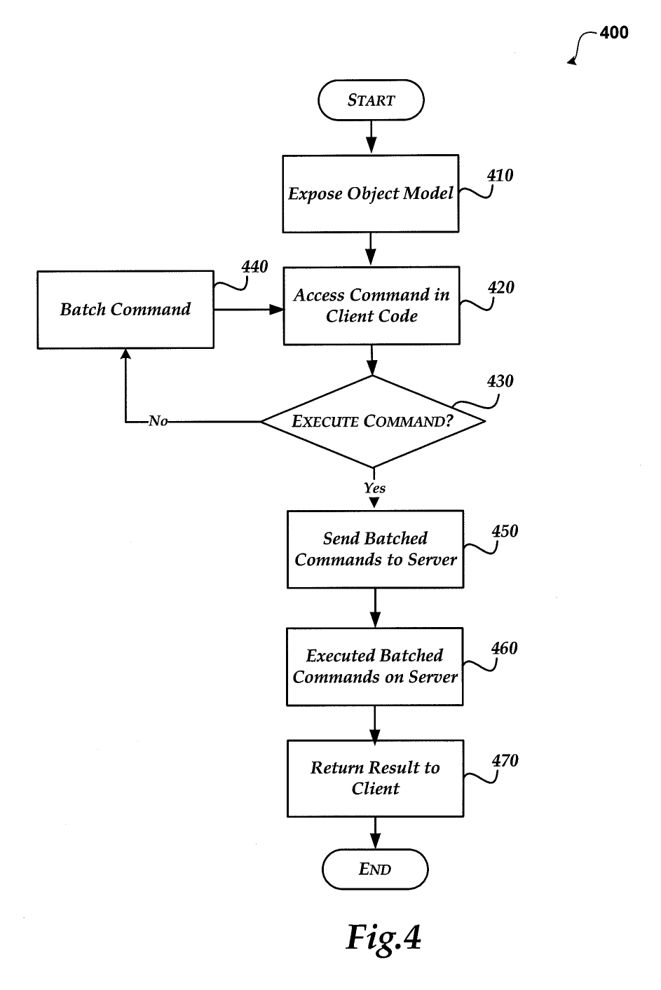

Referring now to FIG. 4, an illustrative process for batching commands is described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 410 where an object model is exposed on the client. As discussed above, the client object model is substantially similar to the server object model. In this way, the programming of the client code is similar to the programming on the server.

Moving to operation 420, each of the commands in the client code are accessed. Until an execute command is received as determined by decision operation 430, each processed command is batched (operation 440). According to one embodiment, the commands in the client code do not explicitly state to be batched. Instead, each command is batched until an execute command is received. According to another embodiment, a specific indicator could be included to batch the command. In this embodiment, the batched commands could be sent to the server for execution on some other condition (i.e. a non-batched command is received).

When the execute command is received, the batched commands are sent to the server for execution (operation 450).

Flowing to operation 460, when the batched commands are received on the server, each of the batched commands are executed using the corresponding server object model.

Moving to operation 470, the results of executing the batched commands are returned to the client. As discussed above, the batched commands may include exception conditions and conditional logic that assists in reducing the communication between the client and the server. The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for batching commands to execute on a server, comprising:
automatically batching commands a client; wherein the commands relate to a client object model on the client and a server object model on the server; wherein the commands to be batched do not include an indication to be batched within client code on the client;
determining when to stop batching the commands;
sending the batched commands to the server;
executing the batched commands on the server; and
receiving a response from the server.

2. The computer-implemented method of claim 1, wherein the client object model is substantially similar to the server object model.

3. The computer-implemented method of claim 2, wherein determining commands from the client object model are directly executable on the server.

4. The computer-implemented method of claim 2, wherein specifying the commands that are available in the client object model includes setting a client callable attribute within the commands in the server object model that are available in the client object model.

5. The computer-implemented method of claim 1 wherein determining when to stop batching the commands the commands comprises determining when an execute command within the client code specifies to execute the commands.

6. The computer-implemented method of claim 1, wherein the batched commands include conditional logic that determines an action to perform on the server based on a result of executing one or more of the batched commands on the server without using a communication with the client to determine the action to perform.

7. The computer-implemented method of claim 1, wherein the server returns a proxy object that is a representation of an object that has not been retrieved by the server; wherein the proxy object is used by the client to perform additional operations on the object.

8. The computer-implemented method of claim 1, wherein the commands include error handling code for performing an operation on the server without using a communication with the client to determine the action to perform based on the error.

9. The computer-implemented method of claim 1, wherein executing the batched commands on the server comprises unpacking each of the batched commands and using the server side object model in executing the commands.

10. A computer-readable storage medium having computer executable instructions for batching commands, comprising:
processing commands within client code on a client to be executed on a server; wherein the commands correspond to a client object model on the client and a substantially similar server object model on the server;
automatically batching each command on the client until a command is processed indicating to stop batching the commands; wherein the commands that are batched do not include an indication within the code to be batched;
sending the batched commands to the server;
executing the batched commands on the server; and
receiving a result from the server.

11. The computer-readable storage medium of claim 10, wherein the batched commands are received by a web service on the server that calls the server object model.

12. The computer-readable storage medium of claim 10, wherein specifying objects and members that are available in the client object model includes setting a client callable attribute within the objects and members in the server object model that are made available in the client object model.

13. The computer-readable storage medium of claim 10, wherein the batched commands include conditional logic that determines an action to perform on the server based on a result of executing one or more of the batched commands on the server without using a communication with the client to determine the action to perform.

14. The computer-readable storage medium of claim 10, wherein the server returns a proxy object that is a representation of an object that has not been retrieved by the server; wherein the proxy object is used by the client to perform additional operations on the object.

15. The computer-readable storage medium of claim 10, wherein the commands include error handling code for performing an operation on the server without using a communication with the client to determine the action to perform based on the error.

16. A system for automatically batching commands on a client for execution on a server, comprising:
a data store that is configured to store a client application and a client object model; wherein the client object model is substantially similar to a server object model on the server;
a network connection that is configured to connect to the IP network;
a processor and a computer-readable medium;
an operating environment stored on the computer-readable medium and executing on the processor; and
a batching manager operating under the control of the operating environment and operative to:
automatically batch each command in a client application on the client until a command is processed indicating to execute the commands;
send the batched commands to the server to be executed on the server when the command indicating to execute the commands is called; and
receive a result from the server from the execution of the commands.

17. The system of claim 16, wherein the batched commands sent to the server are received by a web service on the server that calls the server object model.

18. The system of claim 16, wherein specifying objects and members that are available in the client object model includes setting a client callable attribute within the objects and members in the server object model that are made available in the client object model.

19. The system of claim 16, wherein the batched commands include conditional logic and error handling code that determines an action to perform on the server based on a result of executing one or more of the batched commands on the server without using a communication with the client to determine the action to perform.

20. The system of claim 16, wherein the server returns a proxy object that is a representation of an object that has not been retrieved by the server; wherein the proxy object is used by the client to perform additional operations on the object.
